(19) United States
(12) Patent Application Publication
(10) Pub. No.: US 2016/0140727 A1
(43) Pub. Date: May 19, 2016

(54) A METHOD FOR OBJECT TRACKING

(71) Applicant: ASELSAN ELEKTRONIK SANAYI VETICARET ANONIM SIRKETI, Ankara (TR)

(72) Inventor: Ozgur YILMAZ, Ankara (TR)

(73) Assignee: ASELSAN ELEKTRONIK SANAYI VE TICARET ANONIM SIRKET I, Ankara (TR)

(21) Appl. No.: 14/899,127

(22) PCT Filed: Jun. 17, 2013
(86) PCT No.: PCT/IB2013/054951

§ 371 Date: Dec. 17, 2015

(51) Int. Cl. G06T 7/20; G06K 9/46; G06T 7/00; G06K 9/62

(52) U.S. Cl. CPC G06T 7/20; G06K 9/6267; G06K 9/6256; G06K 9/46; G06K 9/6218; G06K 9/6215; G06T 7/004; G06K 2009/4666

(57) ABSTRACT

The present invention relates to a method for object tracking where the tracking is realized based on object classes, where the classifiers of the objects are trainable without a need for supervision and where the tracking errors are reduced and robustness is increased.

### FIELD OF THE INVENTION

The present invention relates to a method for object tracking where the tracking is realized based on classification of objects.

### BACKGROUND OF THE INVENTION

Primitive surveillance systems used to provide users with periodically updated images or motion pictures. As the expectations on a surveillance system increase, the surveillance systems features must improve. For example, higher frame rates and better picture quality are constant goals. In addition to better sensory input, they are enriched with new algorithmic features. For example, motion detection and tracking features have been implemented in these systems.

There are several ways for achieving object tracking in the state-of-the-art. One of those methods is feature tracking. This method is based on the idea of tacking especially the distinguishing features of the objects to be tacked. However, this method fails to track the target when the target is small (or too far away), or when the image is too noisy. Another method is template matching in which a representative template is saved and used for localizing (using correlation etc.) the object of interest in the following frames. The template is updated from frame to frame in order to adjust to appearance changes. The problem with this approach is its inability to store a wide range of object appearances in a single template, hence its weak representative power of the object.

Another one of tracking, methods is tracking by classification in which the object of interest and the background constitute two separate classes.

The abstract titled “An Analysis of Single-Layer Networks in Unsupervised Feature Learning” (Adam Coates et al.) discloses a method for unsupervised dictionary learning and classification based on the learned dictionary.

The abstract titled “Sparse coding with an overcomplete basis set: A strategy employed by V1?” (Olshausen, B. A., Field, D. J.) discloses usage of sparse representation.

The articles titled “Support Vector Tracking” (Avidan), “P-N Learning: Bootstrapping Binary Classifiers by Structural constraints” (Kalal et al.). “Robust Object Tracking with Online Multiple Instance Learning” (Babenko et al.), “Robust tracking via weakly supervised ranking SVM” (Bai et al.) disclose methods for classification based tracking of objects.

The article titled “Visual tracking via adaptive structural local sparse appearance models” (Jia et al.) discloses a method for using sparse representation for target tracking.

The United States patent application numbered US2006165258 discloses a method for tracking objects in videos with adaptive classifiers.

Classification based methods, although shown to be more powerful than other approaches, still suffer from drifting caused by image clutter, inability to adjust to appearance changes due to limited appearance representation capacity and sensitivity to occlusion due to lack of false training rejection mechanisms.

### OBJECTS OF THE INVENTION

The object of the invention is to provide a method for object tracking where the tracking is realized based on classification of objects.

Another object of the invention is to provide a method for object tracking where the classifiers of the objects are trainable without a need for supervision.

Another object of the invention is to provide as method fix object tracking where the tracking errors are reduced and robustness is increased

Another object of the invention is to provide a method for object tracking where the trained classifiers are stored in a database in order to be reusable.

### BRIEF DESCRIPTION OF THE DRAWINGS

A method for object tracking in order to fulfill the objects of the present invention is illustrated in the attached figures, where:

FIG. 1 is the flowchart of the method object tracking.

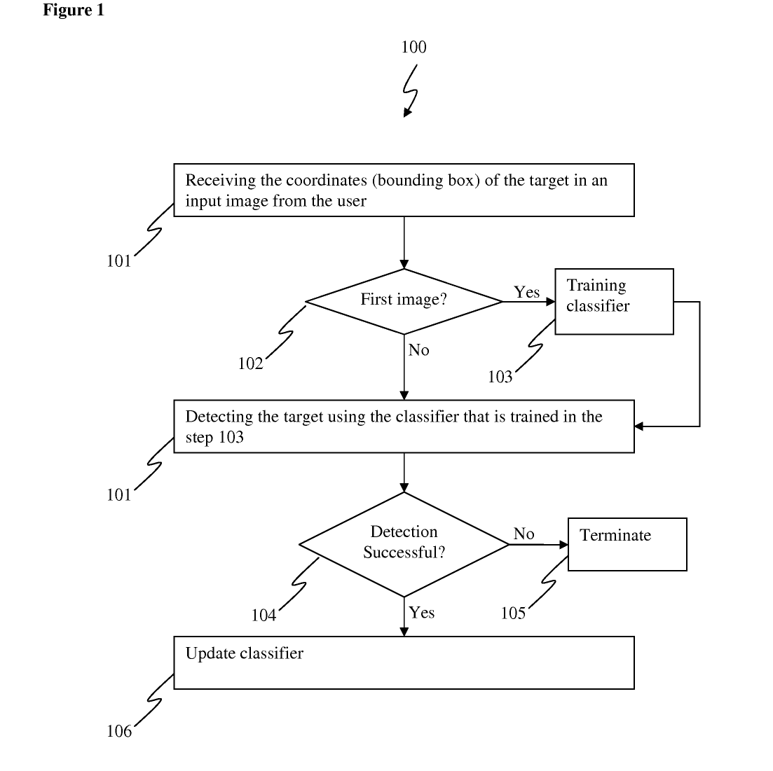

FIG. 2 is the flowchart of the sub-steps of step 103.

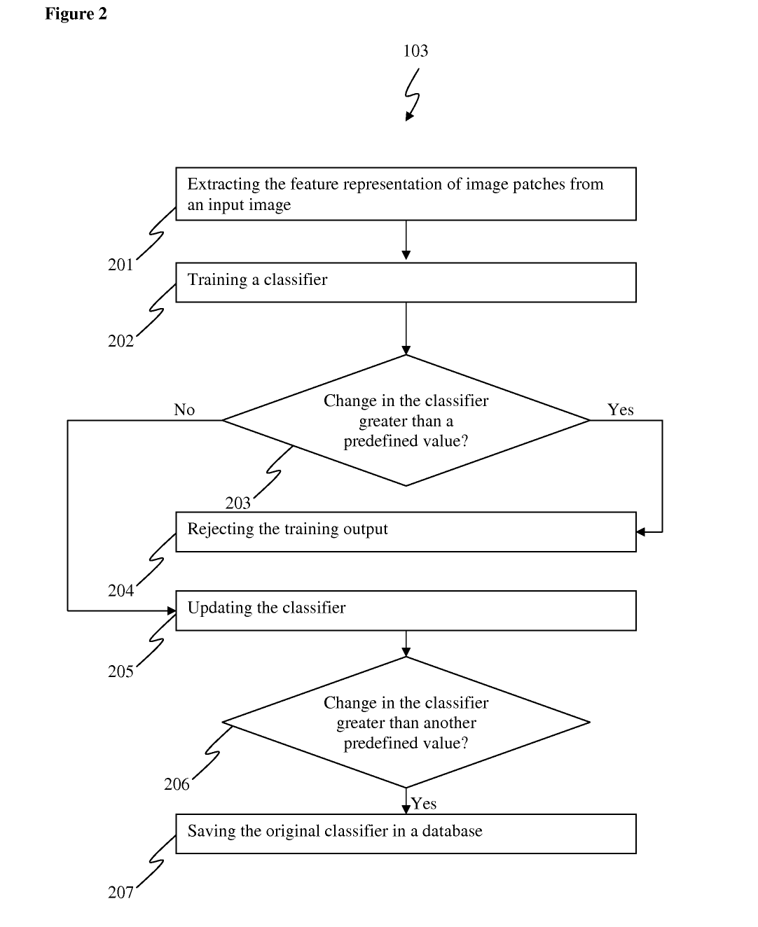

FIG. 3 is the flowchart of the sub-steps of step 104.

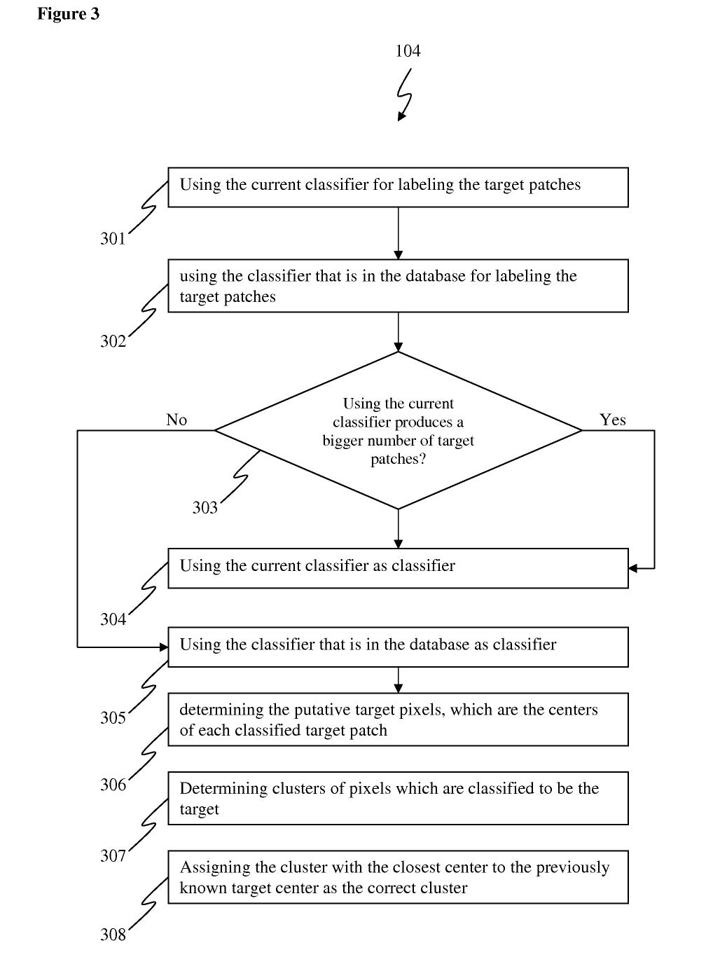

### DETAILED DESCRIPTION OF THE INVENTION

A method for object tracking (100) comprises the steps of:
receiving the coordinates (bounding box) of the target in an input, image from the user (101),
determining if the acquired image is the first image acquired or not (102),
if the acquired image is the first image acquired then training of a classifier discriminates target from the background (103),
if the acquired image is not the first image acquired then detecting the target using the classifier that is trained in the step 103. (104),
determining if the detection is successful or not (105),
if the detection is successful then updating the classifier (106),
if the detection is unsuccessful for a predefined number of consecutive frames then termination of tracking (107).

In the preferred embodiment of the invention, the step 103 comprises the sub-steps of:
extracting the feature representation of image patches from an input image (201),
training a classifier (202),
determining if the change in the classifier is greater than a predefined value (203),
if the change in the classifier is greater than a predefined value then rejecting the training output (204),
if the change in the classifier is not greater than a predefined value then updating the classifier (205),
comparing the change in the classifier with another predefined value (206),
if the change in the classifier is greater the said another predefined value, then saving the original classifier in a database (207)

In the preferred embodiment of the invention, the step 104 comprises the sub-steps of;
using the current classifier for labeling the target patches (301),
using the classifier that is in the database for labeling the target patches (302),
comparing the number of patches acquired in the steps 301 and 302 (303),
if using the current classifier for labeling the target patches produces a bigger number of target patches then using the current classifier as classifier (304),
if using the classifier that is in the database for labeling the target patches produces a bigger number of target patches by a predetermined ratio then using the classifier that is in the database as classifier (305),
determining the putative target pixels, which are the centers of each classified target patch (306),
determining clusters of pixels which are classified to be the target (307),
assigning the cluster with the closest center to the previously blown target center as the correct cluster (308).

In the method for object tracking (100), the coordinates (bounding box) of the target in an input image that is supplied by an imaging unit or a video feed, is acquired from the user (101). After acquiring the bounding box, the processed image frame is evaluated in order to determine if it is the first image frame or not (102). If the image is the first image acquired, then there cannot be any classifiers trained for the target that is wanted to be tracked. Hence, a classifier is trained (103). If the image is not the first image acquired then the target is detected using the classifier that is trained in the step 103 (104). After detecting the target positions, success of the detection is evaluated (106). If the detection is successful then the classifier is updated in order to better separate the target from the background (107). If the detection is unsuccessful for a predefined number of consecutive frames then the tracking is terminated (108).

In the preferred embodiment of the invention, the classifier is trained as follows. The feature representation of image patches is extracted from the input image (201). Afterwards a linear classifier is trained (202). As the classifier is trained, it is compared with a previously trained classifier (203). If the change in the trained classifier is greater than a predefined value then the training is ignored and the process is stopped (204). If the change in the trained classifier is not greater than a predefined value then the classifier is updated (205). Afterwards, the change in the classifier is compared with another predefined value (206). If the change in the classifier is greater than the said another predefined value, then the original classifier is saved in a database (206). As a result, new target appearances are learned and stored, and the appearance database is updated without the need of supervision.

In the preferred embodiment of the invention, detection is realized as follows:

Image patches are extracted around the last known location of the target, that are the same size as the target. The sampling scheme of image patch extraction can be adjusted according to the size and speed characteristics of the tracked object. The image patches are labeled using the current classifier that has been trained (301). The image patches are also labeled using the classifiers that are in the database (302). Numbers of label of target patches generated in the steps 301 and 302 are then compared (303). If using the current classifier for labeling the target patches produces a bigger number of target patches, then the current classifier is used as classifier (304). If one of the classifiers that is in the database produces as bigger number of target patches by a predetermined ratio, then the classifier that is in the database is used as classifier (305). This ensures that the tracking system remembers a previously stored appearance of the target. Afterwards, the putative target pixels, which are the centers of each classified target patches, are determined (306). These target pixels are clustered according to their pixel coordinates and the clusters of pixels are determined (307). The cluster center closest to the previously known target center is then assigned as the correct cluster (308). Clustering of target pixels and selection of closest cluster avoids drill of target location due to clutter or multiple target instances. In a preferred embodiment of the invention, the number of clusters can be determined by methods such as Akaike Information Criterion (Akaike, 1974).

In the preferred embodiment of the invention, the deter position of the target is compared with the position of the target in the previous image frame. If the difference between the positions of the target is unexpectedly high or more than one target appears in the latter frame, then the tracking can be evaluated as inconsistent.

In the preferred embodiment of the invention, once the classifier is trained, it is used for detecting the target by means of distinguishing it from the background. Once the target is detected, its position is updated on the image. In this embodiment, the classifier is further trained in every frame. This periodic training enables plasticity to appearance changes.

In the preferred embodiment of the invention, multiple instances of the classifier is saved and utilized. This provides the tracker an appearance memory; in which representation of the target is very efficient.

The step extracting a sparse feature representation of image patches from an input image (201) provides a representation of the target in a high dimensional feature space, hence the discrimination of target from the background is accurate and robust.

In the preferred embodiment of the invention, the trained classifiers are stored in a database so that they can be used later when they are needed again. Thus, when the tracked object makes a sudden motion and to previously observed target is observed again, it is recognized instead of being declared lost.

In the preferred embodiment of the invention, the classifiers that differ from the previous classifier by more than a predefined value are neglected. This provides rejecting false trainings due to tracking errors or occlusions.

1. A method for object tracking, comprising the steps of:
S1: receiving a plurality of coordinates (bounding box) target in an input image from the user,
S2: determining if an acquired image is the first image acquired or not,
S3: if the acquired image is the first image acquired then training of a classifier that discriminates target from the background,
S4: if the acquired image is not the first image acquired then detecting the target using the classifier that is trained in the step,
S5: determining if the detection is successful or not,
S6: if the detection is successful then updating the classifier,
S7: if the detection is unsuccessful for a predefined number of consecutive frames then termination of tracking,
wherein the step of S3 further comprising the sub-steps of:
extracting the feature representation of image patches from an input image,
training a linear classifier,
determining if the change in the classifier is greater than a predefined value,
if the change in the classifier is greater than a predefined value then rejecting the training output,
if the change in the classifier is not greater than a predefined value then updating the classifier,
if the change in the classifier is greater than another predefined value, then saving the original classifier in a database.

2. (canceled)

3. The method for object tracking of claim 1, the step S4 further comprising the sub-steps of:
S41: using the current classifier for labeling the target patches that is image patches extracted around the last known location of the target,
S42: using the classifiers that are in the database for labeling the target patches,
S43: comparing the number of patches acquired in the steps S41 and S42,
S44: if using the current classifier for labeling the target patches produces a bigger number of target patches, then using the current classifier as classifier,
S45: if one of the classifiers that is in the database produces a bigger number of target patches by a predetermined ratio then assigning that classifier in the database as the current classifier,
S46: determining the putative target pixels, which are the centers of each classified target patch,
S47: determining clusters of pixels which are classified to be the target,
assigning the cluster center closest to the previously known target center as the correct cluster center.

4. The method for object tracking as in claim 1, wherein the determined position of the target is compared with the position of the target in the previous image frame, and if the difference between the positions of the target is unexpectedly high or more than one target appears in the latter frame, then the tracking is evaluated as inconsistent.

5. The method for object tracking of claim 1, wherein if there are more than one target detected in the latter frame, then the target closest to the position of the target in the previous. flame, is considered the target in question.

6. The method for object tracking of claim 1, wherein multiple instances of the classifier is saved and utilized, providing the tracker an appearance memory.

7. The method for object tracking of claim 1 wherein the trained classifiers are stored in a database so that they can be utilized again during tracking when the target appearance changes.

8. The method for object tracking of claim 1 wherein the classifiers that differ from the previous classifier by more than a predefined value are neglected, providing rejecting false trainings due to tracking errors or occlusions and enhancing robustness.

9. The method for object tracking of claim 2, wherein if there are more than one target detected in the latter frame, then the target closest to the position of the target in the previous frame, is considered the target in question.

10. The method for object tracking of claim 2, wherein multiple instances of the classifier are saved and utilized, providing the tracker an appearance memory.
